(19) United States
(12) Patent Application Publication
(10) Pub. No.: US 2006/0212624 A1
(43) Pub. Date: Sep. 21, 2006

(54) Data transceiver using LVDS and a portable terminal employing the same and method therefor

(75) Inventor: Dong-Hwan Kim, Gyeonggi-do (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Pantech Co., Ltd.

(21) Appl. No.: 11/372,494

(22) Filed: Mar. 9, 2006

(30) Foreign Application Priority Data
Mar. 21, 2005 (KR) 10-2005-0023189

(51) Int. Cl. G06F 13/38

(52) U.S. Cl. 710/62

(57) ABSTRACT

A data transceiver using LVDS (low voltage differential signaling) and a portable terminal employing it and a method therefor can cut off an electromagnetic interference (EMI) that occurs upon a high rate data communication and saving an electric power by doing a data communication using LVDS transmission scheme. The portable terminal comprises a USB (universal serial bus) transceiver for receiving a voltage via a USB data cable connected to a data transceiver using an external LVDS, and transmitting and receiving data through a USB device coupled with the USB data cable and the data transceiver, and a controller for recognizing a connection between the data transceiver and the USB data cable based on the voltage provided through the USB data cable and the USB transceiver, and controlling the data transceiver in accordance with a data transfer rate of the USB data cable.

### FIELD OF THE INVENTION

The present invention relates to a data transceiver using LVDS (low voltage differential signaling) and a portable terminal employing it and method therefor; and more particularly, to a data transceiver using LVDS and a portable terminal employing the same and method therefor that are capable of cutting off an electromagnetic interference (EMI) that occurs upon a high rate data communication and saving an electric power by doing a data communication using LVDS transmission scheme.

### DESCRIPTION OF THE RELATED ART

There will be introduced in the following embodiment an example showing that a data transceiver using LVDS is applied to a high rate data communication of a portable terminal.

The portable terminal used herein refers to a portable terminal such as PMP (portable multimedia player), digital camera, game machine, or the like as well as a wireless communication terminal such as PCS (personal communication services) terminal, PDA (personal digital assistant) terminal, smart phone, IMT-2000 (International Mobile Telecommunication-2000) terminal, wireless LAN terminal, or the like.

In the following embodiment, the portable terminal will be given as the wireless communication terminal for the sake of illustration.

The biggest advantage of the wireless communication terminal among other things is that it can provide calling and called users with mobility. Owing to the mobility, the number of wireless communication subscribers has been increased in a geometrical progression, and the wireless communication terminal has widely been utilized by the general public in recent years.

However, as time goes on, such a mobility merit is gradually forgotten from the users of the wireless communication terminal; and, instead, a multifunctional wireless communication terminal capable of offering more various supplementary services is required.

To meet such requirement, most of recently introduced wireless communication terminals are provided with a variety of supplementary functions such as radio broadcasting reception, music reproduction (such as MP3, MPEG layer 3, etc.), finger-pressure, blood sugar level sensing, ultrasound photographing, and the like, in addition to a camera function. Especially, the music reproduction function is one of supplementary functions that have been spotlighted from the younger generation.

On the other hand, to reproduce a music file via a wireless communication terminal, it is available to download the music file onto the wireless communication terminal by wireless communication. In such a case, however, since an extra cost is needed for the wireless communication, a computer is usually employed for the download of the music file. In addition, a camera function of the wireless communication terminal is often used to take a photograph and upload it onto computer.

In this case, the wireless communication terminal is coupled with the computer via such a data cable as USB (universal serial bus) data cable so as to download a music file or upload an image file.

The USB data cable is a cable that is used for connecting between peripheral equipments in a serial transmission mode in case that those equipments employ same connectors.

And also, the USB data cable is a kind of serial port and functions as an interface to solve any inconveniences that are caused by a slow speed of existing external extension ports (serial or parallel ports) and limited equipment connection.

Further, such a USB data cable may connect at a time basic peripheral equipments such as key board, monitor, mouse, printer, modem and so on, which are coupled in different ways.

Moreover, when new peripheral equipments are connected, the USB data cable may not only couple maximum 127 equipments by automatic recognition without rebooting or sep-up process but also transfer data at a maximum 128 Mbps rate, wherein 5 V (minimum 4 V) is required as a drive voltage and ±3.3 V for data transfer.

Also, the USB data cable doesn't need additional equipments because its installation is easy due to a perfect support of PnP (plug-and-play) and USB controller is contained in most of main board chip sets. In recent years, since USB chip set and terminal are involved in the main board, it has been more convenient to use USB related equipments.

As illustrated in FIG. 1, a USB data cable 130 is physically connected to a wireless communication terminal via a USB transceiver 120 of the wireless terminal. As such, if the USB data cable 130 is coupled with the USB transceiver 120, a drive voltage of +5 V of the USB data cable is applied via a USB data power input terminal of the USB transceiver 120. Then, a controller 110 connected to the USB transceiver 120 recognizes the connection of the USB data cable by sensing the supply of the power. Further, the controller 110 communicates with external equipments connected to the USB data cable 130 through a data plus DP terminal and a data minus DM terminal of the USB transceiver 120.

On the other hand, there is adopted in the prior art a USB data cable of standard 1.1 that supports both a low transfer rate of 1.5 Mbps and a high transfer rate of 12 Mbps, as a data communication rate via the USB data cable.

However, to satisfy the needs of users who want a higher rate data communication more and more, a USB data cable of standard 2.0 is introduced for the higher data communication in recent years.

The USB data cable of standard 2.0 supports a communication rate of 480 Mbps as well as 1.5 Mbps and 12 Mbps.

In the meantime, as the data communication rate becomes at the higher rate as set forth above, EMI component is increased, thereby leading to a malfunctioning of the wireless communication terminal.

To prevent such problem, a damping resistor is added as shown in FIG. 1. However, even though the damping resistor prevents EMI that occurs while data transfers at the rate of 1.5 Mbps or 12 Mbps, it can't fully remove EMI component caused by a data bit stream of the higher rate (e.g., 480 Mbps).

Accordingly, there has existed an urgent need for a method capable of preventing a malfunctioning of a wireless communication terminal owing to EMI while supporting a higher data communication.

### SUMMARY OF THE INVENTION

It is, therefore, a primary object of the present invention to provide to a data transceiver using LVDS and portable terminal employing it and method therefor that are capable of cutting off EMI that occurs upon a higher rate data communication and saving an electric power by performing a data communication using LVDS transmission scheme.

In accordance with one aspect of the present invention, there is provided a portable terminal comprising: a USB (universal serial bus) transceiver for receiving a voltage via a USB data cable connected to a data transceiver using an external LVDS (low voltage differential signaling), and transmitting and receiving data through a USB device coupled with the USB data cable and the data transceiver; and a controller for recognizing a connection between the data transceiver and the USB data cable based on the voltage provided through the USB data cable and the USB transceiver, and controlling the data transceiver in accordance with a data transfer rate of the USB data cable.

In accordance with another aspect of the present invention, there is provided a data transmission and reception method for use in a portable terminal, the method comprising the steps of: recognizing a connection between a data transceiver and a USB data cable if a drive voltage of the USB data cable is received; finding a data transfer rate upon a data reception and creating a control signal based on the data transfer rate to thereby allow a first or third data transmission path to be in a conduction state; receiving the data via the conducting data transmission path; finding a data transfer rate upon a data transmission and creating a control signal based on the data transfer rate to thereby permit a second or third data transmission path to be in a conduction state; and transmitting the data via the conducting data transfer path.

The other objectives and advantages of the invention will be understood by the following description and will also be appreciated by the embodiments of the invention more clearly. Further, the objectives and advantages of the invention will readily be seen that they can be realized by the means and its combination specified in the claims.

### BRIEF DESCRIPTION OF THE DRAWINGS

The above and other objects and features of the instant invention will become apparent from the following description of preferred embodiments taken in conjunction with the accompanying drawings, in which:

FIG. 1 provides a view of explaining a connection between a conventional wireless communication terminal and a USB data cable;

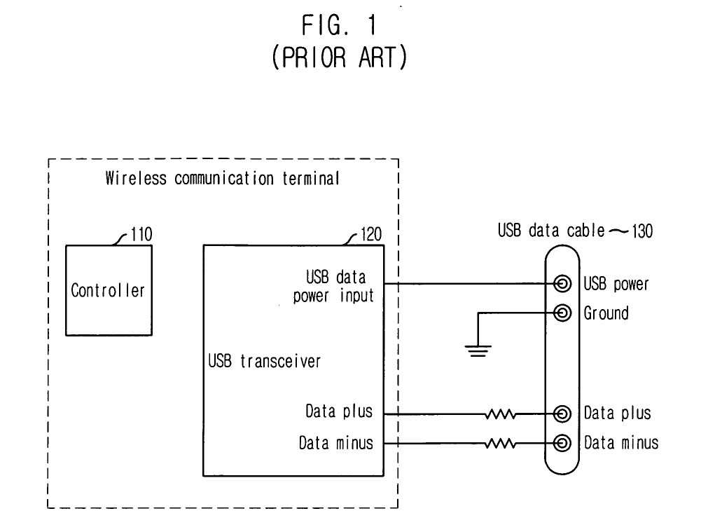

FIG. 2 is an exemplary configuration diagram showing one embodiment of a data transceiver using LVDS and a wireless communication terminal associated therewith in accordance with the present invention; and

FIG. 3 presents an exemplary flowchart illustrating one embodiment of a method where a wireless communication terminal transmits and receives data in gear with a data transceiver using LVDS upon high data communication in accordance with the present invention.

### DETAILED DESCRIPTION OF THE INVENTION

The above-mentioned objectives, features, and advantages will be more apparent by the following detailed description in association with the accompanying drawings; and based on the foregoing, the technical spirit of the invention will readily be conceived by those skilled in the art to which the invention belongs. Further, in the following description, well-known arts will be not described in detail if it appears that they could obscure the gist of the invention in unnecessary detail. Hereinafter, a preferred embodiment of the present invention will be described in detail with reference to the accompanying drawings.

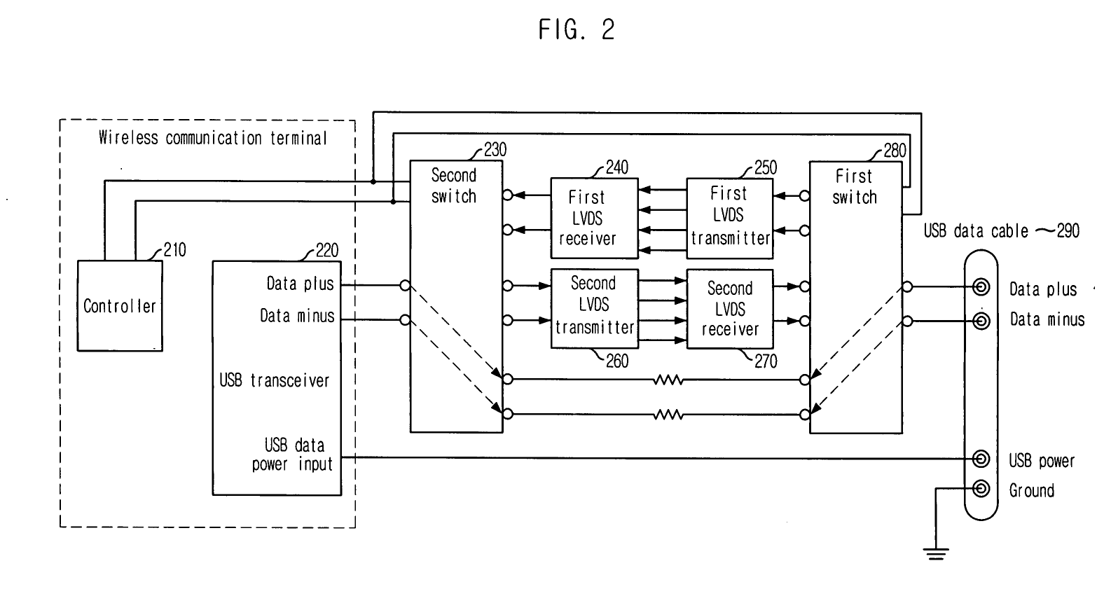

FIG. 2 is an exemplary configuration diagram showing one embodiment of a data transceiver using LVDS and a wireless communication terminal associated therewith in accordance with the present invention.

As illustrated in FIG. 2, the inventive data transceiver using LVDS comprises a first and a second switches 280 and 230, a first and a second LVDS receivers 240 and 270, and a first and a second LVDS transmitters 250 and 260.

The LVDS is known as a universal interface standard for a higher rate data transmission.

The LVDS provides a higher bit rate, a lower electric power, and an improved noise control performance. Due to the verified rate, low electric power, noise control and cost advantage, the LVDS is widely utilized in point-to-point applications for telecommunication, data communication, display, etc. Moreover, since LVDS employs a high rate analog link technique, a multi-gigabit data transmission is available for copper mutual connection.

Of course, standard communication protocols such as IEEE (institute of electrical and electronics engineers) 1394, optical fiber channel, gigabit Ethernet, and so on are often used for the high data transmission between systems. However, since the cost burden of hardware and software for the standard communication protocol between the systems is considerably large for data transmission between them, simple and inexpensive LVDS links are generally employed.

Further, since the LVDS requires a low voltage, a possibility of an issuance of EMI is lowered, which decreases affection to adjacent circuits and also is more advantageous for EMI inspection that becomes more severe in recent years. And also, the consuming power is decreased because the LVDS needs the low voltage.

On the other hand, the wireless communication terminal connected to the data transceiver using LVDS, which gets a drive voltage of the USB data cable via it, comprises a USB transceiver 220 for communicating data with a USB device, and a controller 210 for controlling a data transmission path to cut off EMI upon a high rate data communication.

The USB transceiver 220 includes a data plus terminal and a data minus terminal for the data communication with the USB device connected to the wireless communication terminal and the USB data cable, and a USB data power input terminal for getting the drive voltage of the USB data cable.

The controller 210 recognizes a connection of the USB data cable and a connection of the data transceiver using LVDS associated therewith in accordance with the drive voltage of the USB data cable supplied via the USB data power input terminal of the USB transceiver 220.

In addition, the controller 210 may find a state (pull-up state) of data transmission line (path) via the data plus and minus terminals of the USB transceiver 220, and also acknowledge a data transfer rate through the USB data cable based on the state found.

And also, the controller 210 judges whether or not the data transfer rate through the USB data cable is greater than a threshold, and creates a control signal to conduct at an appropriate data transfer rate based on the judgment result.

In the following embodiment, it is assumed that the threshold of the data transfer rate is set to 100 Mbps. The invention is of course not limited to this embodiment.

Meanwhile, in case the data plus line is pulled up in hardware, initialization message, etc. are initially exchanged at a rate of 12 Mbps, regardless of the version of the USB data cable and the data transfer rate supported by the wireless communication terminal.

Further, the USB device connected to the USB data cable confirms during the initialization process if the wireless communication terminal can support a rate of 480 Mbps; and if so, after the initialization process, it transmits and receives data at a rate of 480 Mbps, instead of 12 Mbps, upon the actual data communication.

However, if the wireless communication terminal can't support the rate of 480 Mbps, the USB device continues to transmit and receive the actual data at the rate of 12 Mbps.

Namely, although the USB device can support USB 2.0, it can transmit and receive data even at a rate of USB 1.1 depending upon the data transfer rate that can be supported by the wireless communication terminal associated therewith.

On the other hand, if the controller 210 recognizes the communication of data at the rate of 480 Mbps, it issues a control signal and then controls the first and the second switches 280 and 230 so that the data transmission path using LVDS is in a conduction state to cut off EMI caused by the communication of data at the rate of 480 Mbps.

For instance, if the wireless communication terminal can's support the rate of 480 Mbps, i.e., if it continues to transmit and receive actual data at the rate of 12 Mbps, since EMI caused by the communication of data at the rate of 12 Mbps may be broken by a damping resistor. Hence, the controller 210 issues the same control signal as that of the initialization process for the first and the second switches 280 and 230 to maintain in the same state as in the initialization process because it continuously communicates the data via the transmission path for the initialization data.

In the meantime, in case the data minus line is pulled up in hardware, the controller 210 recognizes the communication of data at the rate of 1.5 Mbps via the USB data cable.

In such a case, the initialization message and actual data are transmitted at the rate of 1.5 Mbps for the initialization process.

Further, since EMI caused by the rate of 1.5 Mbps can be broken by the damping resistor, the controller 210 issues a control signal and in turn controls the first and the second switches 280 and 230 to allow the data transmission path including that damping resistor to be in a conduction state.

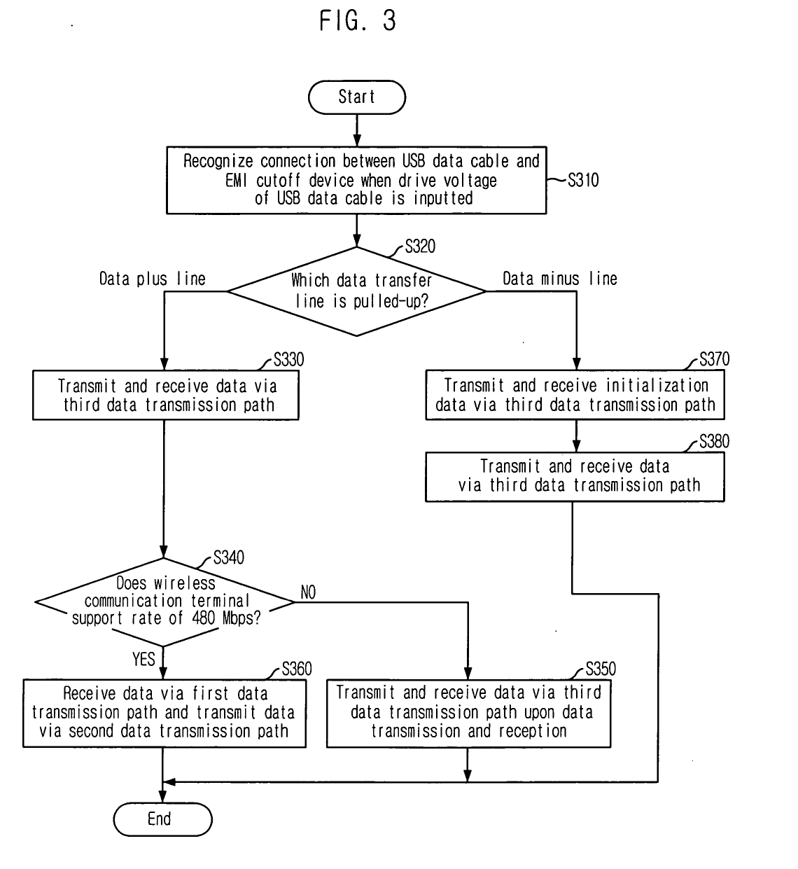

FIG. 3 is an exemplary flowchart illustrating one embodiment of a method where the wireless communication terminal transmits and receives data in gear with the data transceiver using LVDS upon the high data communication in accordance with the present invention.

First of all, it is assumed that the transmission paths for transmitting and receiving data between the wireless communication terminal and the USB device are provided as a first, a second, and a third data transmission paths.

In the foregoing, the first data transmission path includes a first LVDS transmitter 250 and a first LVDS receiver 240, and the second data transmission path contains a second LVDS transmitter 260 and a second LVDS receiver 270.

Further, the third data transmission path has a damping resistor.

Specifically, at a first step S310, the controller 210 recognizes a connection of the USB data cable and a connection of the data transceiver using LVDS associated therewith in accordance with the drive voltage of the USB data cable provided via the USB data power input terminal of the USB transceiver 220.

At a next step S320, the controller 210 finds a data transmission line pulled up via the data plus and minus terminals of the USB transceiver 220.

From the finding step S320, if the data plus line is pulled up, initialization data is communicated at a rate of 12 Mbps between the controller 210 and the USB device. At this time, the controller 210 recognizes the communication of data at a lower rate than a threshold; and then creates a third control signal and controls the first and the second switches 280 and 230 to thereby communicate the initialization data via the third data transmission path at step S330.

If the initialization process has been completed by communicating the initialization data as set forth above, the USB device confirms at step S340 whether the wireless communication terminal supports USB 2.0, i.e., the rate of 480 Mbps.

As mentioned above, the process for the USB device to confirm whether the wireless communication terminal supports USB 2.0 confirms by means of the initialization message, etc., during the initialization process, which is obvious to those skilled in the art; and therefore, details thereof is omitted here for the sake of simplicity.

If it is confirmed at step S340 that the wireless communication terminal doesn't support USB 2.0, the controller 210 continues to transmit and receive actual data at a rate of 12 Mbps via the third data transmission path. At this time, since the 12 Mbps rate is lower than the threshold, at step S350 the controller 210 issues the same third control signal as that of the initialization process for the first and the second switches 280 and 230 to maintain in the same state as that of the initialization process.

However, if it is confirmed at step S340 that the wireless communication terminal supports USB 2.0, the controller 210 transmits and receives the actual data at the rate of 480 Mbps via the first and the second data transmission paths.

At this time, since 480 Mbps is greater than the threshold, at step S360 the controller 210 issues the first control signal and then controls the first and the second switches 280 and 230 to permit the first data transmission path to be in a conduction state upon the reception; and issues the second control signal and then controls the first and the second switches 280 and 230 to allow the second data transmission path to be in a conduction state upon the transmission. By doing so, the EMI component caused by the high rate data communication can be broken by means of the LVDS ways.

In the meantime, if it is confirmed at step S320 that the data minus line is pulled up, the controller 210 creates the third control signal and then controls the first and the second switches 280 and 230 for conduction of the third data transmission path so that the controller 210 and the USB device can transmit and receive the initialization data at a rate of 1.5 Mbps, i.e., a lower rate than the threshold.

After completing the initialization process as set forth above, since data is communicated at a lower rate than the threshold, i.e., 1.5 Mbps even upon actual data communication, at step S380 the controller 210 generates the same control signal to maintain the first and the second switches 280 and 230 in the same state as that of the initialization process to continuously transmit and receive the data via the same data transmission path.

As set forth above, in the case of the higher rate data communication, the present invention can cut off EMI caused by the higher rate bit stream and also save a power by requiring a lower electric power employing LDVS ways.

The method of the present invention as mentioned early may be implemented by a software program and stored in storage medium such as CD-ROM, RAM, ROM, floppy disk, hard disk, optical magnetic disk, etc., which are readable by a computer.

The present application contains subject matter related to Korean patent application No. 2005-0023189, filed with the Korean Intellectual Property Office on Mar. 21, 2005, the entire contents of which are incorporated herein by reference.

While the present invention has been described with respect to the particular embodiments, it will be apparent to those skilled in the art that various changes and modifications may be made without departing from the spirit and scope of the invention as defined in the following claims.

What is claimed is:

1. A portable terminal comprising:
a USB (universal serial bus) transceiver for receiving a voltage via a USB data cable connected to a data transceiver using an external LVDS (low voltage differential signaling), and transmitting and receiving data through a USB device coupled with the USB data cable and the data transceiver; and
a controller for recognizing a connection between the data transceiver and the USB data cable based on the voltage provided through the USB data cable and the USB transceiver, and controlling the data transceiver in accordance with a data transfer rate of the USB data cable.

2. The portable terminal as recited in claim 1, wherein the USB transceiver comprises:
a data plus terminal and a data minus terminal for the data transmission and reception between the portable terminal and the USB device; and
a USB data power input terminal for receiving the voltage via the USB data cable.

3. The portable terminal as recited in claim 1, wherein the controller controls the data transceiver to allow a first or second data transmission path to be in a conduction state upon the data transmission and reception at a faster rate than a threshold rate, and to permit a third data transmission path to be in a conduction state upon the data transmission and reception at a slower rate than the threshold rate.

4. A data transmission and reception method for use in a portable terminal, the method comprising the steps of:
a) recognizing a connection between a data transceiver and a USB data cable if a drive voltage of the USB data cable is received;
b) finding a data transfer rate upon a data reception and creating a control signal based on the data transfer rate to thereby allow a first or third data transmission path to be in a conduction state;
c) receiving the data via the conducting data transmission path;
d) finding a data transfer rate upon a data transmission and creating a control signal based on the data transfer rate to thereby permit a second or third data transmission path to be in a conduction state; and
e) transmitting the data via the conducting data transfer path.

5. The method as recited in claim 4, wherein the step b) comprises the steps of:
if the data transfer rate is faster than a threshold rate, producing a first control signal to control the data transceiver for the data reception via the first data transfer path; and
if the data transfer rate is slower than the threshold rate, creating a third control signal to control the data transceiver for the data reception via the third data transfer path.

6. The method as recited in claim 4, wherein the step d) comprises the steps of:
if the data transfer rate is faster than the threshold rate, generating a second control signal to control the data transceiver for the data transmission via the second data transfer path; and
if the data transfer rate is slower than the threshold rate, issuing a third control signal to control the data transceiver for the data transmission via the third data transfer path.
